(19) United States
(12) Patent Application Publication
(10) Pub. No.: US 2026/0199723 A1
(43) Pub. Date: Jul. 16, 2026

(54) Home Fire Fighter

(71) Applicant: Shane Leo Fischer, Lancaster, CA (US)

(72) Inventor: Shane Leo Fischer, Lancaster, CA (US)

(21) Appl. No.: 19/438,332

(22) Filed: Dec. 31, 2025

Related U.S. Application Data
(60) Provisional application No. 63/744,311, filed on Jan. 12, 2025.

(51) Int. Cl. A62C 35/68; A62C 35/20

(52) U.S. Cl. CPC A62C 35/68; A62C 35/20

(57) ABSTRACT

A Home Fire Fighter system integrates with an existing pool or other water source to provide on site firefighting capability. Motorized diverter valves and a dedicated water delivery line redirect the pool pump’s output from normal circulation to a fire hose and/or exterior sprinklers. A weather resistant enclosure houses plumbing, controls, hose storage, and optional backup power with solar charged battery. Simple user interfaces, including an optional remote truck fill station and overhead signage indicating available water volume, enable rapid use by occupants and firefighters during emergencies.

### FIELD OF THE INVENTION

The present invention relates generally to fire protection systems for residential and commercial properties. More particularly, the invention relates to a system that integrates with an existing pool or water storage system to provide emergency firefighting water for homeowner use, fire department use, fire truck filling, and building exterior and roof sprinkler protection, including automated operation and backup power capabilities.

### BACKGROUND OF THE INVENTION

Wildfires and structure fires present significant risks to residential and commercial properties, especially in regions prone to seasonal wildfires, high winds, drought conditions, or limited and unreliable fire department access and municipal water supply. In many such areas, homeowners and business owners have swimming pools or other water reservoirs containing thousands of gallons of water, but this water is seldom configured for rapid deployment as a firefighting resource.

Typical fire trucks responding to residential or neighborhood fires carry only approximately 500–750 gallons of water. Once that onboard supply is exhausted, firefighters may be forced to wait for additional tanker trucks, draft from distant sources, or rely on limited municipal hydrant systems. During recent wildfire events, including in Southern California, many homes were lost because of lack of available water or limited access to water by the responding fire crews.

Existing pool systems are designed primarily for circulation, filtration, and sanitation of pool water, not for firefighting. Conventional systems do not provide a dedicated, high pressure firefighting hose for homeowner or firefighter use, a standardized fire truck fill connection

capable of rapidly filling fire trucks from a pool or on site reservoir, an integrated backup power system that automatically or easily powers the pool pump when utility power is lost or intentionally shut off during fire conditions, automated push button control to switch from normal pool operation to a firefighting mode, a building exterior and/or roof sprinkler system tied to the same water source with controlled diversion of flow, or overhead visual indicators visible to air support or responding firefighters that identify the presence of the system and the amount of available water.

Some standalone sprinkler or fire pump systems exist, and some pool based pump configurations can be modified in an ad hoc manner, but these do not provide an integrated, packaged “Home Fire Fighter” unit installed as a custom, yet standardized, solution tailored to the homeowner’s existing pool mechanical system. They also do not provide coordinated electrical controls, transfer switching, visual indications, permission documentation for firefighter access, and remote fire truck fill options.

Accordingly, there remains a need for a user friendly system that transforms a homeowner’s or business owner’s existing pool or alternate water source into a reliable firefighting system capable of providing high pressure hose water for direct firefighting, supplying exterior and roof sprinklers for structure protection and pre wetting, rapidly filling fire trucks with standardized fittings, and operating under both normal power and backup generator power during emergencies.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter’s scope.

In one aspect, a Home Fire Fighter system is provided that connects to the discharge side of an existing pool pump, and optionally to the suction side, and redirects water through dedicated piping to a fire protection assembly. The fire protection assembly includes at least one

high quality fire hose with nozzle and an associated fire truck fill fitting. The system further incorporates motorized water diverter valves and low voltage controls that allow a user to switch between normal pool circulation and a firefighting mode using push button or rocker switch controls with visual status indicators.

In another aspect, the system includes an electric start generator sized to operate the existing pool pump, together with an electrical transfer switch configured to selectively connect the pool pump to either a utility power source or the generator. The generator may be paired with a solar powered trickle charger to maintain the generator battery in a ready state, allowing the system to operate during utility power outages or intentional power shutdowns associated with wildfire conditions.

In a further aspect, the system can include an upgraded fire sprinkler configuration that delivers water from the pool or an alternate water source to building exterior, soffits, overhang, canopy, and/or roof sprinkler heads. A dedicated sprinkler diverter valve, actuated by an associated control such as a rocker switch labeled “FIRE/SPRINKLER,” permits rapid diversion of flow between the firefighting hose circuit and an exterior sprinkler circuit. A volume control valve may be provided to adjust the sprinkler flow rate.

In yet another aspect, a fire truck connection is provided, either at or near the Home Fire Fighter unit or at a remote location such as a street side or property boundary. This connection is configured to receive a standard fire hose from a fire truck and to fill a typical fire truck water tank at a rate of approximately 60–95 gallons per minute, enabling a standard truck to be filled in about 5–7 minutes from a pool. An optional remote control module located at the street side connection allows firefighters to activate and control the system from that remote location.

In another aspect, the system includes an enclosure or weather hood housing the controls, hoses, generator system or generator interface, and associated piping. The enclosure may bear overhead signage or markings in large, high contrast lettering, for example red on white, with characters on the order of about six inches in height, identifying the Home Fire Fighter unit and indicating the approximate volume of water available for firefighting. These overhead markings are positioned to be visible from aircraft and to responding firefighters, thereby facilitating rapid identification of available water resources during wildfire events.

In a further aspect, the system may include documentation authorizing local fire departments to enter the property and operate the Home Fire Fighter unit in the owner’s absence during an emergency.

The system can be custom sized and configured to integrate with existing pool equipment and piping at residential or commercial properties, while maintaining a standardized control philosophy, component set, and operating procedures. Alternate water sources and pumps may be used on properties without a pool, employing the same or a similar control and water delivery architecture.

Accordingly, the Home Fire Fighter system provides a comprehensive, integrated firefighting life safety solution that leverages existing water resources to enhance property protection and support local firefighting operations.

### BRIEF DESCRIPTION OF THE DRAWINGS

FIG. 1 Schematic of the Home Fire Fighter system showing the pool, pool pump and piping, diverter valve, Home Fire Fighter water line, hose and nozzle, sprinkler line, and enclosure.

FIG. 2 Electrical wiring diagram showing utility power, backup generator, transfer switch, low voltage power supply, valve actuators, and control/indicator circuits.

FIG. 3 Diagram of the enclosure of the present invention.

FIG. 4 Exterior view of a building showing the exterior sprinkler system with sprinkler heads on walls, soffits, and/or roof supplied from the Home Fire Fighter system.

FIG. 5 Site layout view showing the enclosure on the property, a line to a remote truck fill at the property edge near the street, and a remote control interface at the truck fill location.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood,

any embodiment may incorporate only one or a plurality of the above disclosed aspects of the disclosure and may further incorporate only one or a plurality of the above disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing herefrom, which scope is to be defined by the claims and the equivalents thereof. It is not intended that the scope of patent protection be defined by reading into any claim limitation found herein and/or issuing herefrom that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing herefrom. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of methods, systems, apparatuses, and devices for providing a Home Fire Fighter system that integrates with an existing pool water system to supply firefighting hoses, building exterior sprinklers, and fire truck fill connections using pool water under both utility and generator backup power, embodiments of the present disclosure are not limited to use only in this context.

### Reference Numerals for System Components and Environment

### System & Environment

100 – Home Fire Fighter system (overall)

### Pool Hydraulics

110 – Pool pump

116 – Pool bottom drain(s)

118 – Pool skimmer return(s)

### Home Fire Fighter Plumbing

120 – Home Fire Fighter water delivery line

126 – Dedicated fire truck water fill fitting (near enclosure)

### Valves and Flow Control

140 – First motorized diverter valve (POOL/FIRE on discharge side)

142 – Suction side diverter valve

144 – Second motorized diverter valve (FIRE/SPRINKLER)

146 – Sprinkler volume control valve

### Enclosure & Components

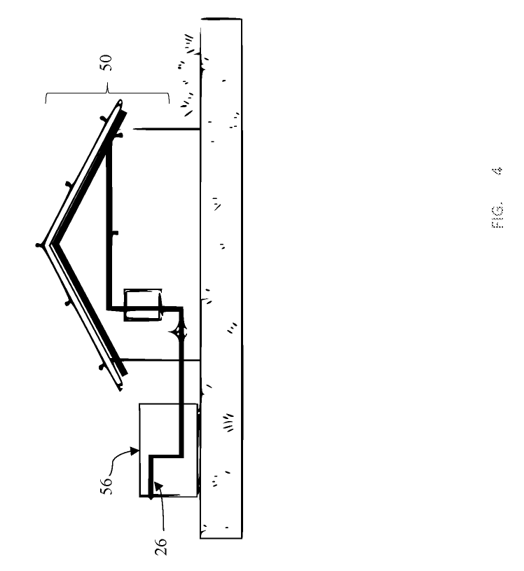

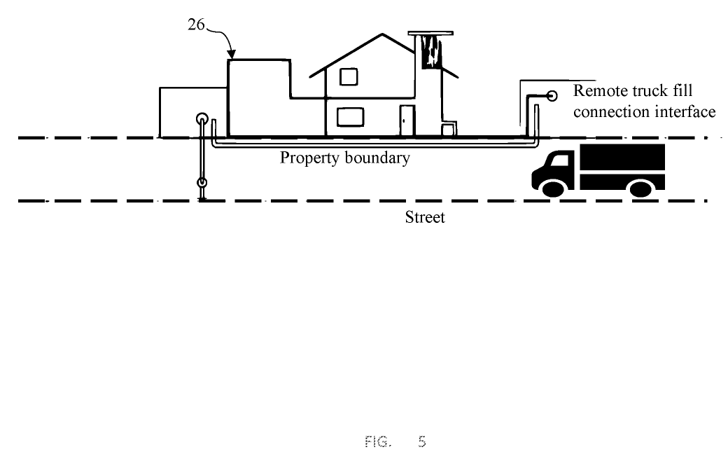

26 – Enclosure / cabinet (shown in FIGS. 4-5)

### Electrical, Controls & Power

162 – Line conductors (L1, L2, N)

164 – Backup generator

166 – Generator battery

168 – Generator starter / ignition circuitry

170 – Power transfer switch

172 – Control transformer (line to low voltage)

176 – Valve actuator for valve 140

178 – Valve actuator for valve 142

180 – Valve actuator for valve 144

195/198 – Low voltage control assembly (combined assembly shown)

### User Interface & Indicators

182 – Pool/Fire selector switch

184 – Fire/Fire Sprinkler selector switch

186 – “POOL” indicator light

188 – “FIRE” indicator light

190 – “SPRINKLER” indicator light

### Hose Assembly Items

50 – Hose assembly (overall / reel)

56 – Stand / frame

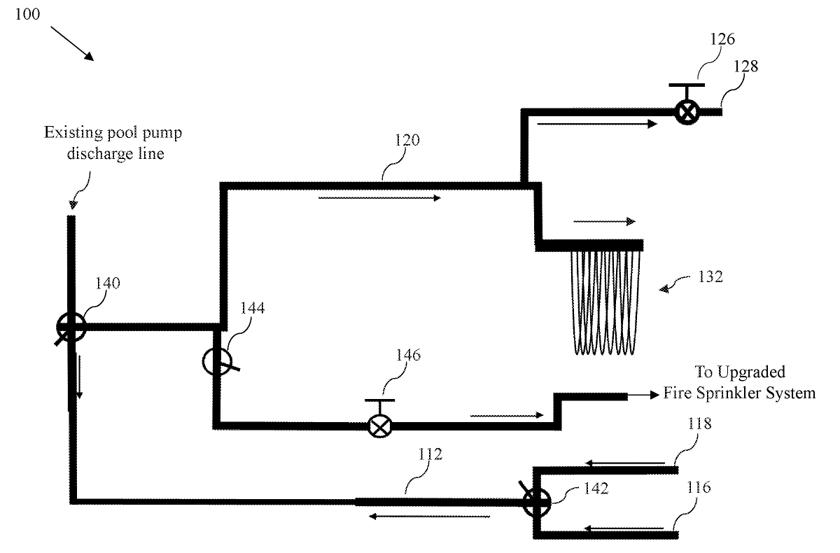

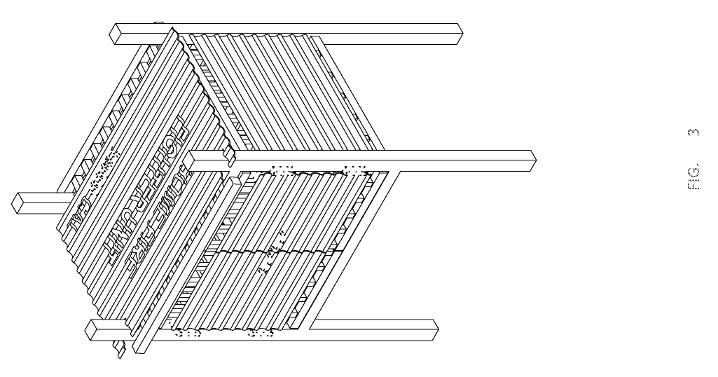

Referring generally to FIGS. 1-5, a Home Fire Fighter system 100 is provided for installation at a property having an existing swimming pool and pool mechanical system, or an alternate water source such as a pond, cistern, or storage tank. The system 100 is configured to utilize water from the pool (or alternate source) for structure protection, property protection, and fire truck fill operations.

The pool mechanical system conventionally includes at least one pool pump 110, a suction side piping network drawing water from the pool via one or more pool bottom drains 116 and pool skimmer returns 118, and a discharge side piping network which returns water to the pool after filtration and optional heating or chemical treatment.

The Home Fire Fighter system 100 integrates with the pool mechanical system to selectively divert water from the discharge side piping to a Home Fire Fighter water delivery line 120 and, optionally, to a sprinkler water delivery line. The Home Fire Fighter water delivery line 120 can be fluidly coupled to multiple outlets, including one or more local fire hose outlets, a dedicated fire truck water fill fitting 126 located near an enclosure, and, where provided, a remote truck fill connection located at or near an edge of the property (see FIG. 5).

In preferred embodiments, the system 100 is pre assembled as a modular Home Fire Fighter system unit housed within an enclosure or cabinet 26, configured for custom tie in to the field conditions at a homeowner’s or business owner’s existing pool equipment pad. The unit 26 can be factory assembled with integrated plumbing, integrated electrical connections, and low voltage controls so that installation primarily involves tying into the existing pool discharge side piping, connecting power, and making control connections as needed.

In some embodiments, the system 100 is provided as a weather resistant enclosure or housing 26 that contains at least a portion of the Home Fire Fighter water delivery line 120, electrical controls, and storage for a fire hose or hose assembly. The enclosure 26 may be mounted on a stand or pad near the pool equipment, and may be configured as a complete, integrated unit that can be dropped in at the site and connected with customized plumbing and electrical tie ins.

### Water Delivery Components – Fire Hose Assembly

In one embodiment, the system 100 includes a high quality fire hose assembly (see, e.g., FIG. 4), which may be supported on a stand or frame 56 and may include a hose assembly or reel 50. The assembly is configured to withstand elevated pressures and flows suitable for firefighting

and to allow rapid deployment and recovery of the hose. The free end of the hose may be equipped with a quick connect fitting to allow rapid exchange between a nozzle and a fire truck connection adapter (not separately numbered, or optionally forming part of an outlet) configured to mate with standard fire service couplings. The proximal end of the hose may also include a quick connect or threaded coupling configured to mate with a fire hose outlet fluidly coupled to the Home Fire Fighter water delivery line 120.

The hose assembly is fluidly connected to the Home Fire Fighter water delivery line 120 via appropriate fittings and valves, as shown schematically in FIG. 1. In operation, when the pool pump 110 is running and the Home Fire Fighter system 100 is in a fire mode, water from the pool is pumped through the pump 110, through a diverter valve as described below, into the Home Fire Fighter water delivery line 120, and out through the hose assembly.

### Diverter Valves and Flow Control

To enable selection between normal pool circulation and firefighting operation, the system 100 employs one or more diverter valves, which in preferred embodiments are motorized and controlled by a low voltage control system.

In one embodiment, a first motorized water diverter valve 140 is installed in the pump discharge side piping to direct water either:

back to the discharge side pool return path in a normal “POOL” circulation mode, or

to the Home Fire Fighter water delivery line 120 in a “FIRE” mode.

The diverter valve 140 may be a motorized two or three way valve actuated by a low voltage control signal. A Pool/Fire water selector switch 182 and indicator lights 186, 188 may be provided on a control panel and wired to a valve actuator 176 of the valve 140 so that the current valve position is clearly indicated to the user. For example, a green LED 186 may indicate the “POOL” position, and a red LED 188 may indicate the “FIRE” position.

In some embodiments, a suction side diverter valve 142 is provided in the pool pump suction piping to allow the pump 110 to draw from one or more of the pool bottom drains 116, pool skimmer returns 118, and/or a dedicated Home Fire Fighter suction connection. The suction diverter valve 142 may also be motorized and controlled by low voltage signals from the low

voltage control system, via a corresponding valve actuator 178, thereby enabling automatic or push button switching of suction sources depending on operating mode.

In addition to the valve 140 on the discharge side, an upgraded configuration may include a second motorized water diverter valve 144 (also referred to as a fire/sprinkler diverter) in the Home Fire Fighter water delivery line 120.

This diverter valve 144 directs the pumped water between:

a “FIRE” position providing water to the hose assembly and local firefighting hose outlets;

a “SPRINKLER” position providing water to a rooftop and/or exterior wall sprinkler network via a sprinkler water delivery line; and

a “FIRE TRUCK” position providing water to an optional edge of property remote truck fill connection, as shown schematically in FIG. 5.

The diverter valve 144 is driven by a valve actuator 180 and can be controlled by a Fire/Fire Sprinkler selector switch 184 on the control panel. Indicator lights 188, 190 on or near the switch 184 may indicate “FIRE” versus “SPRINKLER” positions of the valve 144 so that the active mode is apparent to the user.

A sprinkler volume control valve 146 may be provided in series with or parallel to the sprinkler water delivery line to adjust or limit the flow rate to the sprinkler network, helping to maintain adequate pressure and flow either to the sprinklers or to the hose, or to accommodate varying pool pump 110 capacities.

### Building Exterior Sprinkler System

In one embodiment, a building exterior sprinkler system is provided that is fluidly coupled to the Home Fire Fighter water delivery line 120 downstream of the first diverter valve 140 and upstream or downstream of the second diverter valve 144, depending on layout. In one arrangement, the second diverter valve 144 directs flow either to the hose assembly or to the sprinkler system, permitting “hose mode” or “sprinkler mode” operation.

### Electrical and Control System

### Power Sources and Transfer Switch

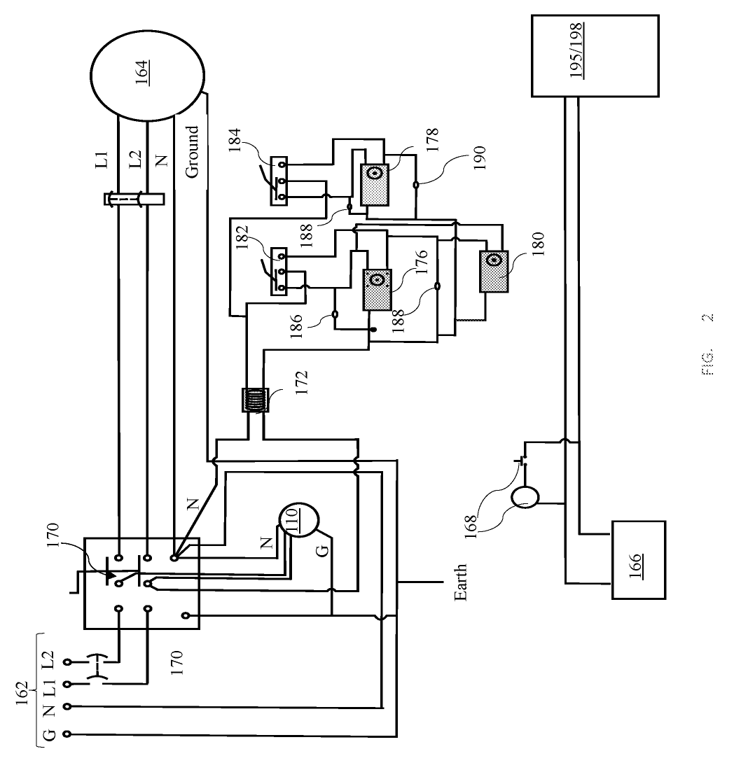

Referring to FIG. 2, the pool pump 110 is normally powered by a utility power source supplying line conductors 162 (e.g., L1, L2, and neutral N). Under non emergency conditions, the pump 110 operates in a conventional manner under the control of existing pool equipment controls and timers, and the diverter valve 140 remains in the “POOL” position.

To ensure operation during power outages or intentional utility shutoffs (for example, during wildfire events or grid de energization), the system 100 further comprises a backup generator 164. The generator 164 may be an electric start generator sized to power the pool pump 110, the low voltage controls, and any indicator lighting. The generator 164 includes a generator battery 166 and starter/ignition circuitry 168.

A power transfer switch 170 is provided to selectively connect the pool pump 110 and related controls either to the utility power source or to the generator 164 power output terminals. The transfer switch 170 may be manually operated, for example by a lever or handle that in a first position connects the pool pump 110 to the utility source and in a second position connects the pump 110 to the generator 164. In other embodiments, the transfer switch 170 may be automatic or semi automatic, sensing loss of utility power and switching over to generator power.

The power transfer switch 170 is electrically coupled to the pump 110, to a Home Fire Fighter system control panel forming part of a low voltage control assembly 195/198, and to both the utility power source and the generator 164, and is configured so that in operation either the utility source or the generator 164 powers the system 100 at a given time, but not both simultaneously.

### Control Power, Low Voltage Control Assembly, and Valve Actuators

A control transformer 172 is provided to step down a line voltage (e.g., 115 V AC or 208/230 V AC single phase) to a low voltage control level (e.g., 24 V AC). The low voltage output has common and hot leads connected to various switch contacts, relay coils within the low voltage control assembly 195/198, indicator lights 186, 188, 190, and valve actuator motors 176, 178, 180.

The motorized diverter valves 140, 142, 144 are each driven by a respective valve actuator 176, 178, 180, which receive control signals from one or more low voltage controls, such as selector switches 182, 184 and other control logic in the low voltage control assembly 195/198. Indicator lights 186, 188, 190 are connected in appropriate circuits to provide visual feedback regarding the valve positions and the current system mode (e.g., pool mode, fire hose mode, sprinkler mode).

The low voltage control assembly 195/198 may include a control power supply, one or more push buttons, rocker switches, indicator lights, or other low voltage controls. In some embodiments, the low voltage controls are configured to provide a substantially “push button” operation: for example, a user may simply press a “FIRE” button to transition the Home Fire Fighter system 100 from a normal pool mode to a fire protection mode.

The low voltage control assembly 195/198 can then automatically energize the appropriate valve actuators 176, 178, 180, set the diverter valves 140, 142, 144 to fire positions, and illuminate indicator lights 186, 188, 190 to show the current mode.

In certain embodiments, the low voltage control assembly 195/198 is configured for complete or near complete automation in running the Home Fire Fighter system 100, including: moving the first motorized water valve 140 between pool and fire positions; moving the second motorized water valve 144 between hose and sprinkler positions; and controlling indicator lighting and any remote control interface. A third motorized valve (not separately numbered) may be provided for an optional edge of property remote truck fill connection (FIG. 5).

### Solar Charger for Generator Battery

In some embodiments, a solar charging arrangement may be provided in combination with the generator 164, with components mounted in or near the enclosure 26 and electrically coupled to the generator battery 166.

### User Interface

The user interface is designed to be simple and intuitive, particularly in emergency situations, and may include:

A Pool/Fire water selector switch 182 on the control panel (e.g., rocker or push button type), labeled “POOL” and “FIRE,” with corresponding indicator lights 186, 188 indicating the active position.

A Fire/Fire Sprinkler selector switch 184, labeled “FIRE” and “SPRINKLER,” with indicator lights 188, 190 indicating whether the hose assembly or an exterior sprinkler system is being fed.

A power transfer switch handle associated with the transfer switch 170 with positions clearly labeled “UTILITY POWER” and “GENERATOR POWER,” and optionally indicator lights distinguishing the active power source.

Generator start instructions posted on or near the generator 164, and possibly a start/stop button or switch for the generator 164.

Operating instruction placards mounted on or inside the enclosure 26, with step by step instructions for fire operation under both utility available and utility unavailable conditions.

The enclosure 26 may further include indicator or interior lighting and mounting structures for the hose assembly 50, 56, valves 140, 142, 144, 146, and the control assembly 195/198, as depicted in the figures.

### Fire Truck Fill Capability

The system 100 may include a fire truck fill capability that allows firefighters to draw water from the pool into a fire truck water tank using the pool pump 110. In one embodiment, a fire truck connection adapter (not separately numbered, or optionally forming part of an outlet) is attachable to the free end of a hose supported by the hose assembly 50 on stand 56. The adapter may be configured to mate with a standard fire truck water tank fill fitting.

In another embodiment, a dedicated fire truck water fill fitting 126 is directly fluidly coupled to the Home Fire Fighter water delivery line 120 near the enclosure 26. In some embodiments, a remote street side fire truck connection (un numbered in the drawings) is provided at or near the edge of the property, fluidly coupled to the Home Fire Fighter water delivery line 120 by above ground or underground piping.

Although the invention has been explained in relation to its preferred embodiment, it is to be understood that many other possible modifications and variations can be made without departing from the spirit and scope of the invention.

What is claimed is:

1. A Home Fire Fighter system, comprising:
a pool containing pool water;
a pool pump forming part of a pool water system and configured to draw the pool water from the pool and return the pool water to the pool under pressure;
a pool discharge line fluidly coupled to a discharge side of the pool pump;
a first motorized water valve:
disposed in the pool discharge line;
having a pool position in which the pool pump discharges the pool water to a normal pool return path returning the pool water to the pool; and
having a fire position in which the pool pump discharges the pool water to a Home Fire Fighter water line;
the Home Fire Fighter water line fluidly coupled to the first motorized water valve when the first motorized water valve is in the fire position;
a fire hose outlet fluidly coupled to the Home Fire Fighter water line;
a fire hose having a length between 100 ft and 400 ft and:
having a proximal end connectable to the fire hose outlet; and
having a distal end provided with a fire nozzle configured to discharge the pool water at a pressure and flow suitable for fire fighting;
a fire truck water fill fitting fluidly coupled to the Home Fire Fighter water line and configured to be connectable to a water tank fill inlet of a fire truck such that the pool pump is operable to deliver the pool water from the pool into a water tank of the fire truck;
a generator backup configured to provide electrical power to at least the pool pump during at least one of a power outage and an emergency power shutdown;
a power transfer switch:
electrically coupled to the pool pump, a utility power source, and the generator backup; and
configured to selectively connect the pool pump to one of the utility power source and the generator backup;
a low voltage control system configured for automated operation of the Home Fire Fighter system and comprising:
a control power supply;
at least one low voltage control for placing the Home Fire Fighter system in a fire protection mode;
at least one motor control connection to the first motorized water valve; and
electrical controls and indicator lighting including LED indicator lighting configured to indicate at least whether the Home Fire Fighter system is in a pool mode or the fire protection mode; and
an enclosure:
housing at least a portion of the Home Fire Fighter water line, the low voltage control system, and storage for the fire hose; and
including externally visible overhead information configured to assist aircraft and fire fighter crew location and to indicate an amount of available pool water for fire fighting,
wherein, when the pool pump is operating and the first motorized water valve is in the fire position, the Home Fire Fighter system is configured to provide fire protection by tying into the pool water system and to deliver the pool water from the pool through at least one of (i) the fire hose and (ii) the fire truck water fill fitting for fire fighting.

2. The Home Fire Fighter system of claim 1, further comprising a building exterior sprinkler system fluidly coupled to the Home Fire Fighter water line and configured for at least one of pre wetting during a wildfire and use during a fire.

3. The Home Fire Fighter system of claim 2, wherein the building exterior sprinkler system comprises a sprinkler water line and a plurality of sprinkler heads located on at least one of an exterior wall, a soffit, and a roof of a building at a property.

4. The Home Fire Fighter system of claim 2, further comprising:
a second motorized water valve disposed in the Home Fire Fighter water line and configured to selectively direct the pool water to the fire hose or to the building exterior sprinkler system; and
a further low voltage control operatively coupled to the second motorized water valve and configured to place the Home Fire Fighter system in a hose mode or a sprinkler mode.

5. The Home Fire Fighter system of claim 1, wherein the low voltage control system is configured such that, with a push button operation, the Home Fire Fighter system is switchable from a normal pool operating mode to a fire protection operating mode.

6. The Home Fire Fighter system of claim 1, wherein the generator backup further comprises a solar charger configured to charge a battery of the backup generator.

7. The Home Fire Fighter system of claim 1, wherein the power transfer switch is a manual power transfer switch configured to be operated by a user to transfer power to the pool pump between the utility power source and the generator backup.

8. The Home Fire Fighter system of claim 1, further comprising a pin rack, a hump rack, or a similar hose rack mounted within the enclosure and configured to store at least the fire hose in a ready to use condition.

9. The Home Fire Fighter system of claim 1, wherein the Home Fire Fighter system is assembled as a complete unit with integrated components and custom tie in and sizing configured to meet field conditions at a pool mechanical system area of a home owner or a business owner.

10. The Home Fire Fighter system of claim 1, wherein the fire truck water fill fitting is configured to provide fire truck fill using water from the pool pumped through the Home Fire Fighter water line.

11. The Home Fire Fighter system of claim 1, further comprising a fire truck fill connection configured to be located at an edge of a property, the fire truck fill connection being fluidly coupled to the Home Fire Fighter water line.

12. The Home Fire Fighter system of claim 11, further comprising remote electronic control of the Home Fire Fighter system at a truck fill location associated with the fire truck fill connection at the edge of the property.

13. A method of providing fire protection using pool water, comprising:
using a low voltage control system to place a first motorized water valve in a fire position to direct pool water from a pool pump into a Home Fire Fighter water line;
connecting a fire hose having a length of at least 100 ft to a fire hose outlet coupled to the Home Fire Fighter water line;
deploying the fire hose to an area to be protected; and
discharging the pool water from a nozzle of the fire hose onto at least one of a home, a building, and surrounding vegetation to provide fire protection from wildfire and home fires.

14. The method of claim 13, further comprising:
operating a generator backup;
operating a power transfer switch to connect the pool pump to the generator backup during at least one of a power outage and an emergency power shutdown; and
running a Home Fire Fighter system on the generator backup.

15. The method of claim 13, further comprising connecting a fire truck water fill fitting fluidly coupled to the Home Fire Fighter water line to a water tank fill inlet of a fire truck and delivering the pool water from the pool through the Home Fire Fighter water line to fill a water tank of the fire truck.

16. The method of claim 15, wherein delivering the pool water from the pool through the Home Fire Fighter water line to fill the water tank of the fire truck comprises providing a fire truck fill using water from the pool pumped through the Home Fire Fighter water line.

17. The method of claim 13, further comprising operating the low voltage control system to direct the pool water from the Home Fire Fighter water line to a building exterior sprinkler system for at least one of pre wetting during a wildfire and use during a fire.

18. The method of claim 13, further comprising using remote electronic control of a Home Fire Fighter system at a truck fill location associated with a fire truck fill connection at an edge of a property.

19. A Home Fire Fighter system unit, comprising:
an integrated plumbing assembly including:
a Home Fire Fighter water line configured to be tied into an existing pool water system;
a first motorized water valve configured to be installed in a pool discharge line and to direct pool water selectively to a normal pool return path or to the Home Fire Fighter water line;
a fire hose outlet coupled to the Home Fire Fighter water line;
a fire truck water fill fitting coupled to the Home Fire Fighter water line; and
plumbing connections configured to be custom tied in and sized to meet field conditions at a pool mechanical system area;
an integrated electrical assembly including:
a generator backup connection for backup generator power;
a power transfer switch configured to selectively connect a pool pump to a utility power source or to the backup generator;
a solar charger connection configured to connect to a solar charger for a generator battery; and
electrical controls, lighting, and LED mode indicator lighting;
a low voltage controls assembly for automated operation of the Home Fire Fighter system unit and including at least one low voltage control configured to operate the first motorized water valve between a pool position and a fire position and configured to provide a push button operation;
a fire hose and a pin rack or hump rack configured to store the fire hose; and
an enclosure configured to house at least the integrated plumbing assembly, the integrated electrical assembly, the low voltage controls assembly, and the fire hose and to include overhead view information configured to assist aircraft and fire fighter crew location and to identify an amount of available pool water for fire fighting,
wherein the Home Fire Fighter system unit is assembled as a complete unit with the integrated components and is configured for installation with custom tie in and sizing to the existing pool water system.

20. The Home Fire Fighter system unit of claim 19, further comprising:
a fire truck fill connection configured to be located at an edge of a property and fluidly coupled to the Home Fire Fighter water line; and
a remote electronic control interface associated with the fire truck fill connection and configured to allow operation of the Home Fire Fighter system unit from a truck fill location.
